(19) United States
(12) Patent Application Publication
(10) Pub. No.: US 2015/0278945 A1
(43) Pub. Date: Oct. 1, 2015

(54) SYSTEMS AND METHODS FOR SOLAR INSTALLATION FINANCING

(71) Applicant: DIVIDEND SOLAR, INC., San Francisco, CA (US)

(72) Inventors: Stephen William MICHELLA, San Francisco, CA (US); Stephen Eric White, JR., San Francisco, CA (US)

(21) Appl. No.: 14/675,092

(22) Filed: Mar. 31, 2015

Related U.S. Application Data
(60) Provisional application No. 61/973,216, filed on Mar. 31, 2014.

(51) Int. Cl. G06Q 40/02

(52) U.S. Cl. CPC G06Q 40/025; G06Q 40/06

(57) ABSTRACT

The present disclosure provides methods and systems for funding solar system installations. A method for funding an installation of a solar system comprises providing a customer a loan for the installation and generating a note that corresponds to the loan. The note can permit an investor to fund at least a portion of the installation. The note can be made accessible to potential investors. An investor can then elect to purchase a given unit of the note.

### CROSS-REFERENCE

This application claims priority to U.S. Provisional Patent Application Ser. No. 61/973,216, filed Mar. 31, 2014, which is entirely incorporated herein by reference.

### BACKGROUND

Solar cells, as part of solar systems, provide an attractive “green” alternative to conventional electric power grids. Using the power of sunlight to generate electricity, solar cells provide a clean, safe, reliable, and efficient source of energy. In the long run, solar cells can provide customers with significant cost savings relative to other sources of electricity. As an incentive to installing solar cells and systems, government entities may provide credits, rebates, or tax deductions to customers who purchase and install solar systems.

A number of factors such as rising cost of traditional forms of energy, volatile and unreliable electricity markets, and an environmental conscientiousness has led many power consumers to seriously consider the alternative of solar energy. The clear benefits of solar energy have led many to contemplate solar energy systems for their homes or places of business. Despite such demand for solar systems, customers have faced a number of impediments in the process of obtaining accurate quotes, securing financing, dealing with government and regulatory issues, and ensuring that solar systems are delivered and installed in a competent and professional manner.

### SUMMARY

Despite the attractiveness of the use of solar cells and systems, the asset class has remained largely inaccessible to a substantial portion of the investing community. In the United States, for instance, the solar asset class is largely inaccessible to tax-exempt and non-U.S. investors, even though these investors have helped to fund U.S. infrastructure development for the last century. These investors are structurally and/or economically restricted from providing tax equity investment given that they are U.S. tax-exempt entities. The limited number of tax equity investors, along with a multi-billion dollar requirement for capital by solar developers and would-be solar owners has resulted in a mispriced financing market and an excessive cost of capital for U.S. solar.

One impediment is the cost and expense involved with obtaining accurate and customized quotes for installing solar systems, and for estimating and visualizing the benefits that result from installation. Customers may also hesitate over what they perceive to be the high cost of solar systems, believing that solar systems cannot fit within their budgets. For customers who receive accurate information about the cost of solar systems and are convinced of the financial and environmental benefits of using solar energy, many will have difficulty paying up-front cash for the entire cost of solar systems. Thus, obtaining financing is another impediment. The environmental attributes and tax credits, rebates and deductions offered to customers by governmental and non-governmental entities are an important incentive for many customers, but understanding, managing, and benefiting from environmental attributes takes time and expertise that customers may not possess. As such, potential solar customers may be kept from accessing attractive financing options for a solar cell installation.

The present disclosure provides systems and methods that can accelerate market equilibrium and dramatically reduce the cost of solar energy, in some cases through a web-based loan financing platform. The platform can connect non-tax-equity-based capital with qualified residential solar borrowers via solar loans, such as, for example, company-originated solar loans. Such loans can provide solar borrowers (e.g., homeowners) with an innovative, streamlined solar financing solution. Solar lending and financing systems herein can drive market efficiency by providing investors with access to a diversified pool of low-risk, asset-backed, residential solar loans.

The present disclosure provides solar financing systems and methods that can connect solar investors with solar borrowers. Systems and methods provided herein can advantageously bring solar borrowers in contact with solar investors, who may otherwise not be brought in contact with such solar borrowers. Investors can be provided with the opportunity to own stable, cash-flowing loans secured by real assets (e.g., U.S. energy infrastructure real assets), which can deliver outsized risk-adjusted financial returns while generating positive environmental and social benefits.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 schematically illustrates a solar financing workflow, in accordance with embodiments of the present invention;

FIG. 2 schematically illustrates another solar financing workflow, in accordance with embodiments of the present invention;

FIG. 3 schematically illustrates an eligibility and pre-qualification workflow, in accordance with embodiments of the present invention;

FIG. 4 schematically illustrates an application process workflow, in accordance with embodiments of the present invention;

FIG. 5 schematically illustrates a funding process workflow, in accordance with embodiments of the present invention;

FIG. 6 schematically illustrates a payment process workflow, in accordance with embodiments of the present invention;

FIG. 7 schematically illustrates a system that can be used to implement solar installation workflows, in accordance with embodiments of the present invention;

FIG. 8 schematically illustrates a performance process workflow, in accordance with embodiments of the present invention;

FIG. 9 shows a computer system that is programmed or otherwise configured to implement solar financing systems and methods provided herein, in accordance with embodiments of the present invention;

FIG. 10 is a screenshot of an investor portal as part of a user interface (UI) of a system for solar financing, in accordance with embodiments of the present invention; and

FIG. 11 is a screenshot of a UI that is displayed when the far-left note of FIG. 10 is selected, in accordance with embodiments of the present invention.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “solar cell,” as used herein, generally refers to a photovoltaic solar cell, which is a device that is configured to generate electricity upon exposure to light.

The term “solar system,” as used herein, generally refers to a system that comprises one or more solar cells. In a solar system, multiple solar cells can be electrically connected in series, parallel, or a combination of parallel and series connectivity.

The term “customer” or “solar customer,” as used herein, generally refers to an individual, multiple individuals or entity (e.g., company) that wishes to install a solar system. A solar customer can be a business owner or homeowner.

The present disclosure provides systems and methods that can simultaneously mitigate two widespread, fundamental deficiencies in the residential solar finance market. First, homeowners currently have limited options for financing residential solar. In particular, some opportunities for financing residential solar are predicated on complex tax equity financing vehicles limited to a small subset of the investment community. Second, private and institutional investors are increasingly turning to alternative private asset classes for opportunities that generate outsized risk-adjusted returns; however, these asset classes are largely inaccessible to even sophisticated investors due to their fragmentation and/or nascence.

The present disclosure provides solar financing systems and methods that can leverage information technology and securities regulations to connect new investment capital directly to a diverse pool of asset-backed solar loans. A solar financing system can provide a streamlined, convenient solution for installers to access credit on behalf of homeowners. In some situations, a third party can underwrite and originate loans, such as, for example, operating as a clearinghouse for competitive capital, thereby encouraging borrower costs to fall as demand for high-quality solar loans grows.

Solar financing methods of the present disclosure enable a solar borrower to realize at least some, most, all, or substantially all of the benefits of ownership of a solar system, including any and all rebates and tax credits, all of the value of electricity generated from the solar system, home value appreciation, and penalty-free prepayment.

In some embodiments, solar financing is facilitated by a facilitator (e.g., a third party company) that connects solar investors with solar customers. Solar customers can be homeowners. Solar installations can be performed by an installation partner. The facilitator can provide installation partners with participation in the long-term economics of performing installations through an operations agreement. This profit share can be paid out of the facilitator's annual trailing interest servicing revenue and can provide the installer with long-term, recurring economic upside on each and every installation that is performing within a given limit, such as, for example, within 50%, 40%, 30%, 20%, 15% or 10% of upfront system projections provided to the homeowner.

The facilitator can provide solar customers with the ability for rapid pre-approval for a solar loan, such as pre-approval within 5 minutes, 4 minutes, 3 minutes, 2 minutes, 1 minute, thirty seconds, or less than thirty seconds. Such pre-approval can be made using, for example, one or more criteria selected from credit scores (e.g., FICO scores), borrower income, borrower mortgage debt, and borrower total debt, as well as other financial considerations. As the solar customer moves through confirmatory credit due diligence, the facilitator can represent that at least 50%, 60%, 70%, 80%, 90%, 95%, or 99% of homeowners that were pre-approved will qualify for final loan approval, representing a high-degree of reliability and higher close-rates for installation partners. As a solar-as-a-service solution, the facilitator can provide customers with full-lifecycle support and maintenance.

The facilitator can provide a qualified solar customer with a loan for a solar installation. Such a loan can be designed and structured to maximize value and minimize execution risk of a forthcoming securitization transaction. The loan characteristics that support a securitization transaction may include, but are not limited to, a multi-pronged underwriting process. The multi-pronged underwriting process may evaluate borrower credit-risk, installer quality control, balance sheet stability, pre-approved solar hardware, and independent, third-party quality assurance inspections on a sample of the originated portfolio. Another loan characteristic that may support a securitization transaction may be young assets that generate immediate and consistent borrower savings on a periodic (e.g., month-to-month) basis. An additional loan characteristic may include inverter, operations, and maintenance reserves. Standardization of hardware manufacturers and processes, as well as diversification of an asset base—both across tier I module manufacturers and installations located in multiple geographies—may also be loan characteristics that may support a securitization transaction.

Additional loan characteristics may include implementation of standardized monitoring equipment across entire asset pool and historical asset performance; borrower contributions and obligations, such as equity value creation using mortgage-style amortization and tax credit principal buy-down after a given time period (e.g., sixteen-eighteen months); and elimination of a solar industry's reliance on a third-party tax equity provider by enabling borrowers to own the solar asset and realize some or all of the full 30% investment tax credit. Further loan characteristics may include extended workmanship and PV system production guarantees; presence of a back-up loan servicer; presence of a back-up asset servicer providing a backstop on the facilitator's installer network in the event a given installer is unable to fulfill their obligations; and migration away from a complicated lease securitization with cash flow variability to an asset-backed securitization with known monthly payments or yield-based equity security that can grow distributions over time so as to serve as an inflation mitigator.

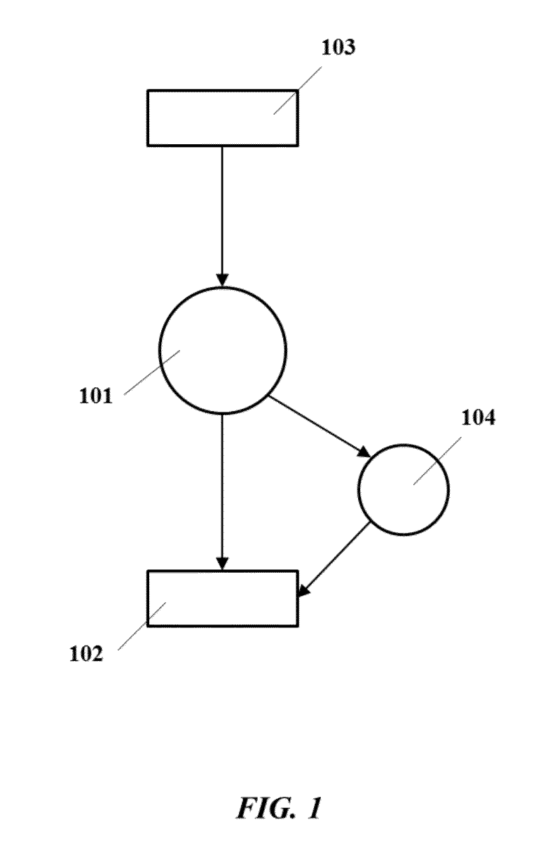

FIG. 1 schematically illustrates a solar financing workflow, in accordance with embodiments of the present invention. A facilitator 101 of solar installations may provide a qualified solar customer (e.g., homeowner) 102, among one or more solar customers, with a loan for a solar system installation. The loans provided by the facilitator 101 can be backed by investment from one or more solar installation investors 103. The solar customer 102 may provide repayment of the loan at terms that may be individualized for the solar customer 102. Additionally, the facilitator 101 may also connect a solar installer 104 with the solar customer 102. The solar installer 104, in turn, can provide the solar installation for the solar customer 102.

Facilitator 101 can fund the solar installation by paying the installer 104 for the installation. The solar customer 102 can then repay the facilitator 101 under terms negotiated between the facilitator 101 and the solar customer 102. Thus, the facilitator 101 may provide the solar customer 102 a loan for the solar installation. The loan provided by the facilitator can be backed by investment from the solar installation investors 103. Additionally, the facilitator 101 can charge a platform and technology services fee (e.g., 5% of the cost for installation) to the solar installer 104.

In examples, the investors 103 can fund solar installations that satisfy certain investor criteria. Such criteria can include the credit score (e.g., FICO score), income, total debt, mortgage debt, and geography or location of a solar customer, such as solar customer 102. Additionally, factors related to the equipment being installed, such as the manufacturer of the equipment that is included in the solar installation, may also be used as investor criteria. The investors 103 can each select such criteria.

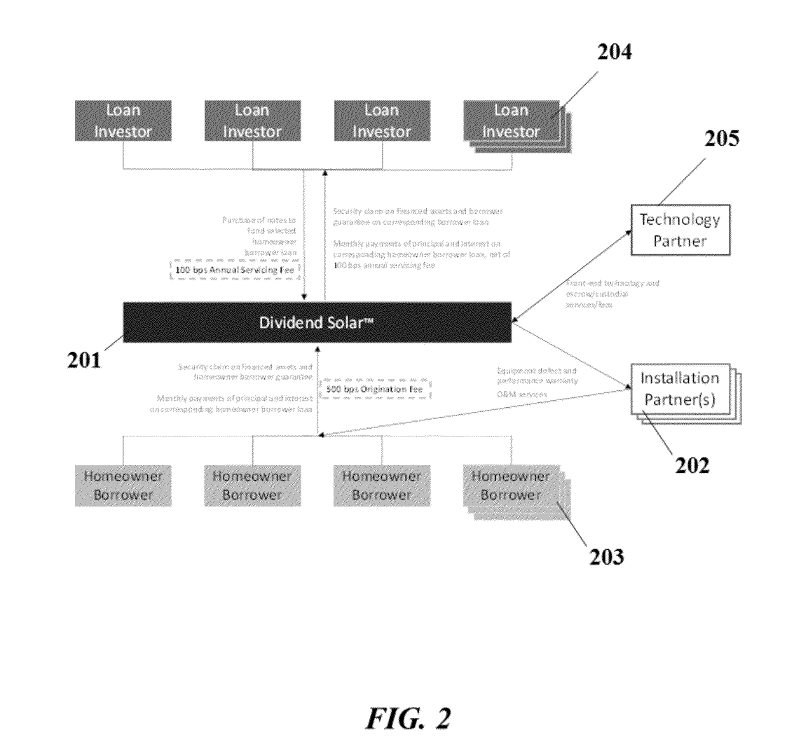

FIG. 2 shows another solar financing workflow, in accordance with embodiments of the present invention. The workflow includes a facilitator 201, recognized in FIG. 2 as “Dividend Solar™”, that is in communication with solar installers 202. Solar installers 202 can direct homeowners 203 that are interested in making solar installations to a computer system of the facilitator 201. The facilitator 201, in turn, may underwrite and originate a loan for a solar installer to a qualified homeowner 203. The loan may then be funded off the balance sheet of facilitator 201 and distributed directly to the solar installers 202. The solar installation can be distributed to the solar installers 202 in one or more stages. In some examples, the solar installation may be directed to the installers 202 in three stages following achievement of one or more pre-determined milestones. Examples of pre-determined milestones include initial loan signing, equipment delivery, system construction completion, and grid interconnection.

In examples, the facilitator 201 can be a counterparty and lender to a homeowner 203 that has been approved for a loan for a solar installation. During or following the completion of a solar installation for a homeowner 203, the facilitator 201 can provide at least one loan investor 204 with the opportunity to invest in a promissory note that is dependent on the solar loan. The note can be provided via a front-end investor platform, such as a web-based platform. In an example, the note may provide investors with payments from dependent loan obligations. The payments may be assessed with a net of a 1% interest servicing fee. In other examples, the interest servicing fee can be at least about 0.1%, 0.5%, 1%, 2%, 3%, 4% or 5%.

In an example, a $30,000 solar installation can provide an installation partner, such as a solar installer 202, with an income of at least about $1,250 over a 15-year term. In another example, based on one hundred installations in the first year and growing by 20% annually thereafter, an installation partner could receive greater than about $500k of annual income and greater than about $2.7 million of cumulative income over a 15-year term.

With continued reference to FIG. 2, facilitator 201 can provide multiple notes, each associated with a given loan for a particular solar installation for one of the homeowners. A note can correspond to a particular loan and the associated interest and principal payments and underlying collateral value, where the underlying collateral value can be secured (e.g., via a uniform commercial code (UCC) filing). In such a case, the facilitator 201 can be the counterparty and borrower with respect to the loan investors 204. In some cases, the note can have no recourse to the facilitator 201 beyond the value associated with the underlying loan to the homeowner 203—for example, if the homeowner 203 does not pay, then the facilitator 201 would not have to pay the loan investor 204.

The facilitator 201 can be a lender to the homeowner 203 and creditor to the loan investor 204. The homeowner 203 can repay the facilitator 201 under terms that may be negotiated between the facilitator 201 and the homeowner 203. Additionally, the facilitator 201 can repay the loan investor 204 under terms that may be negotiated between the facilitator 201 and the loan investor 204.

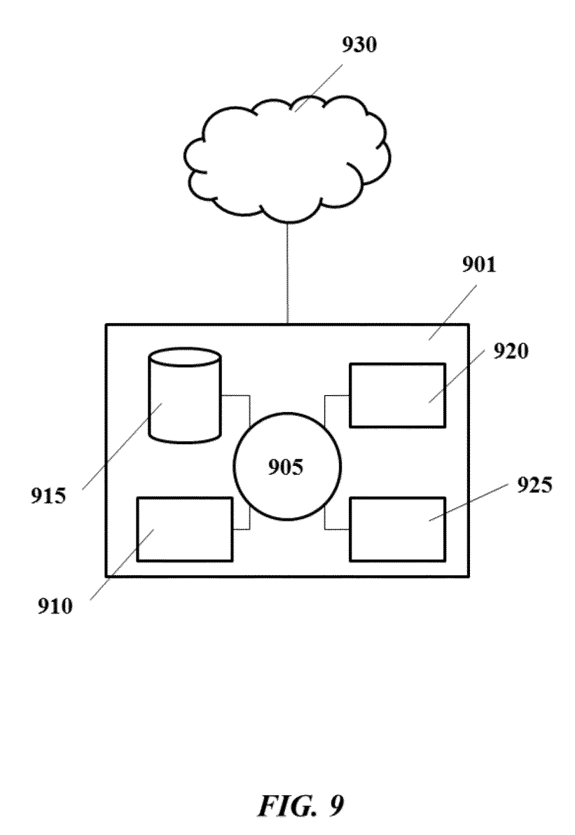

The workflow of FIG. 2 can be implemented by a computer system (see, e.g., FIG. 9) that can include a user interface to enable the facilitator 201 to interact with the solar installer 202, homeowner 203 and loan investor 204. In an example solar installation scenario, the system may provide that the solar installer 201 with a calculator widget that can inform the solar installer 201 that the application of the homeowner 203 is either “likely” or “unlikely” to be approved for a loan for the solar installation. The pre-qualification can be on the basis of credit score (e.g., FICO score), borrower income, borrower mortgage debt, and borrower total debt. In examples, the solar installer 202 can remain anonymous with respect to the homeowner 203.

The workflow of FIG. 2 may include a technology partner 205 that can provide the backend (e.g., server) and front end (e.g., user interface) systems to implement the workflow. The technology partner 205 can provide one or more computer servers that are programmed to implement a transaction between the facilitator 201 and the homeowner 203, and/or a separate transaction between the facilitator 201 and the loan investor 204.

The facilitator 201 can provide the homeowner 203 a loan with a loan structure that includes an annual rate graduator which attracts incremental low-cost investor capital while impacting borrowers minimally. For example, over the 20-year life of a $30,000 loan, with a starting annual rate of 6.50%, the average incremental borrower monthly interest payment is $5.61 when applying an annual graduation of 1% to the starting annual rate of 6.50% (e.g., a 0.065% annual increase).

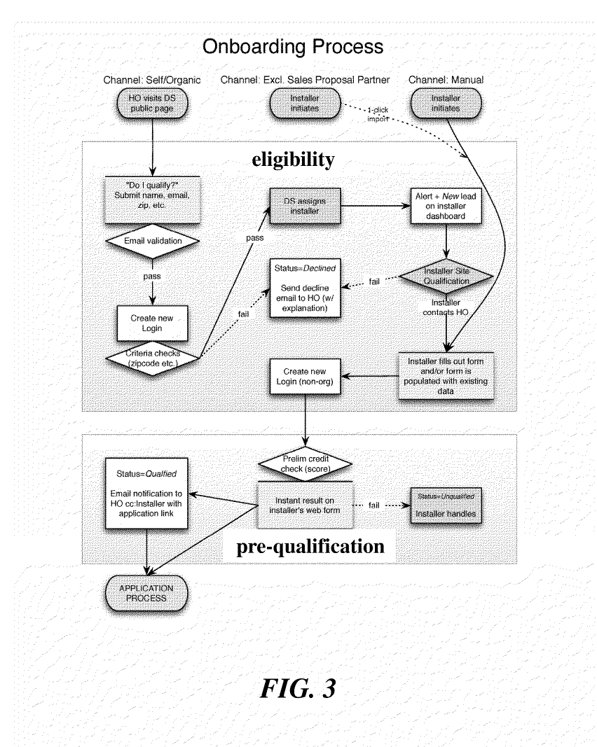

FIG. 3 schematically illustrates an eligibility and pre-qualification workflow as part of an onboarding process for a new customer (e.g., homeowner), in accordance with embodiments of the present invention. The onboarding process can be implemented by a computer system that is programmed to facilitate solar financing (see, e.g., FIG. 9). A homeowner may access the computer system to determine whether he or she may qualify for a solar installation loan. As part of the eligibility assessment, the homeowner may submit identifying information (e.g., name, address and email). The system may then determine whether the homeowner is eligible for a loan using, for example, the address of the homeowner. If the homeowner is eligible, the facilitator may assign the homeowner to a solar installer; otherwise, the facilitator may decline the homeowner's eligibility and send the homeowner a not-eligible communication (e.g., email). If the homeowner is eligible, the facilitator may notify the solar installer about the homeowner, and the solar installer can then perform a site qualification of the homeowner to determine whether the homeowner's home is suitable for the solar installation. Additionally, the system may enable the installer or homeowner to proceed to a pre-qualification step in which the system performs a credit check of the homeowner. If the homeowner passes the credit check (“Pre-qualified”), then the system may contact the homeowner to finish the application process for a loan. The system may also notify the installer that the homeowner has pre-qualified for the loan. Alternatively, an installer can onboard a homeowner through its own sales process, in which case the installer may determine the homeowner is eligible in its own right before attempting to pre-qualify the homeowner in the manner described above.

The homeowner can fail a credit check if a credit score of the homeowner is below a first limit, such as below 725. If the credit score is greater than a second limit (e.g., 780), then the credit check may pass. If an income of the homeowner is below a certain amount (e.g., $100,000/year) or if a mortgage to income ratio is greater than a given limit (e.g., 40%), then the credit check may fail. Otherwise, if the credit score is above the first limit, then the credit check may pass.

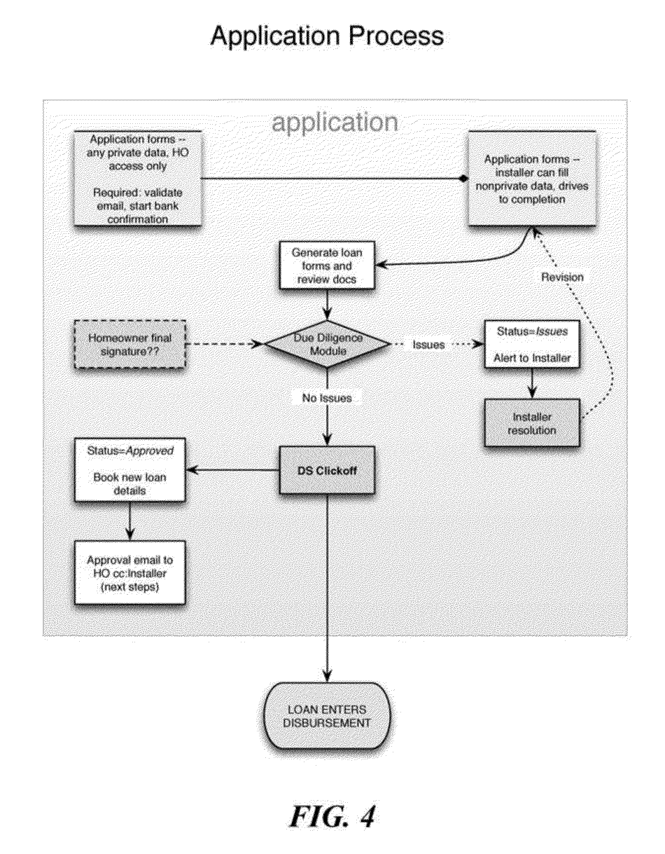

FIG. 4 schematically illustrates an application process workflow, in accordance with embodiments of the present invention. As part of the application process, the homeowner may validate an email address, or into a homeowner user interface (or portal), accept a registration agreement, upload supporting documentation to validate proof of income, and-or enter bank account/information. The installer may provide a sales proposal to the facilitator at this time. The sales proposal can be accessible by the system. The sales proposal can include installation timing and cost projections, as well as potential savings. The facilitator may then the homeowner's application and the installer's proposal in a due diligence module. If there are any issues with the homeowner's application, including validation of the homeowner's bank account to be debited, the installer and/or homeowner may be notified. If there are no issues (“Final Approval”), then the system directs a loan agreement to be created for execution by the homeowner. Alternatively, the installer may auto-create the loan agreement before Final Approval and send it on a contingent basis to the homeowner for execution; in this latter case, the loan agreement is not final until Final Approval has been achieved. Once Final Approval has been achieved and the homeowner executes the loan, the system may enter a funding process workflow.

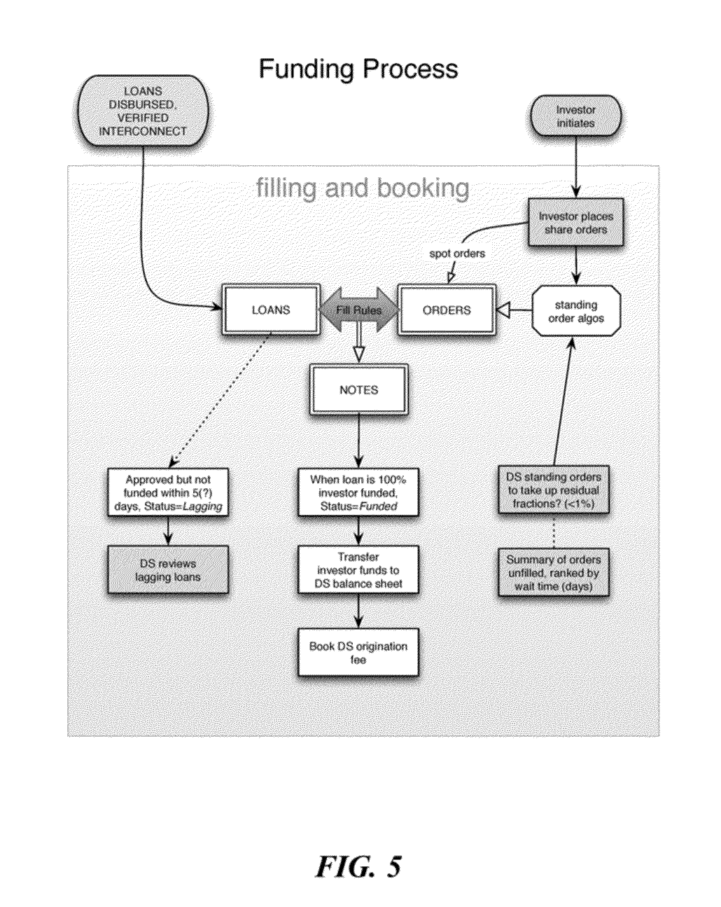

FIG. 5 schematically illustrates a funding process workflow, in accordance with embodiments of the present invention. In particular, FIG. 5 shows the fulfillment of notes that may be dependent on a particular solar system loan. As part of this process, once a loan has been fully funded by the facilitator, following the achievement of a certain milestone(s) (i.e., construction completion), a corresponding note investment opportunity may be posted to the investor front-end platform, which can include an investor user interface (or portal). Once an opportunity has been posted to the front-end investor platform, investors may have the opportunity to place spot orders to participate in note opportunities. Additionally, opportunities can be filled with standing orders of capital. Once a particular opportunity has been filled, investors can be notified of order acceptance, and funds can be disbursed from their investor accounts (e.g., via a Custodial Account). If an opportunity remains not funded or not entirely funded after a certain period of time from posting, as determined by the facilitator (e.g., 5 days), the opportunity can be classified as “lagging” and the facilitator can review the opportunity and no funds will be required.

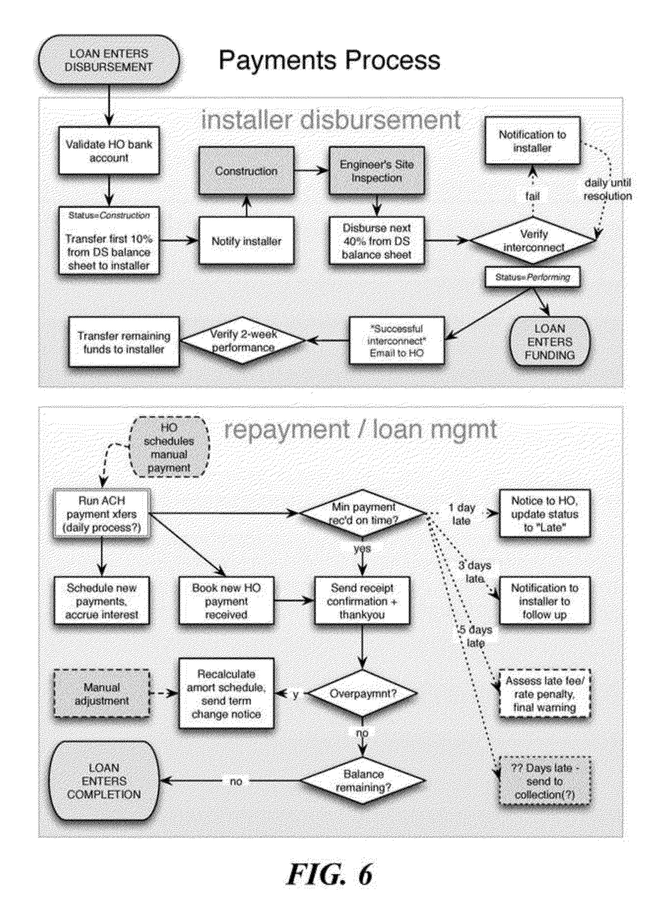

FIG. 6 schematically illustrates a payment process workflow, in accordance with embodiments of the present invention. The top portion of the figure shows an installer disbursement workflow. Once a solar installation loan has entered disbursement, the system can subsequently transfer portions of the loan amount from the facilitator to the installer at predesignated milestone achievements. For example, the system can transfer 20% of the loan amount to the installer. The installer can then be notified of the transfer. Construction of the solar installation can then begin. Following a successful completion of construction, at least a portion of the remainder of the loan amount (e.g., 65% of the loan amount) can be transferred from the facilitator to the installer. The performance of the solar installation can then be verified, such as by testing interconnection (e.g., to a power grid) of the solar installation. The performance of the installation over a given period of time (e.g., one week) can then be assessed. If the interconnect and performance are successful, the remainder of the loan amount may be transferred from the facilitator to the installer. The bottom portion of FIG. 6 schematically illustrates homeowner loan repayment management.

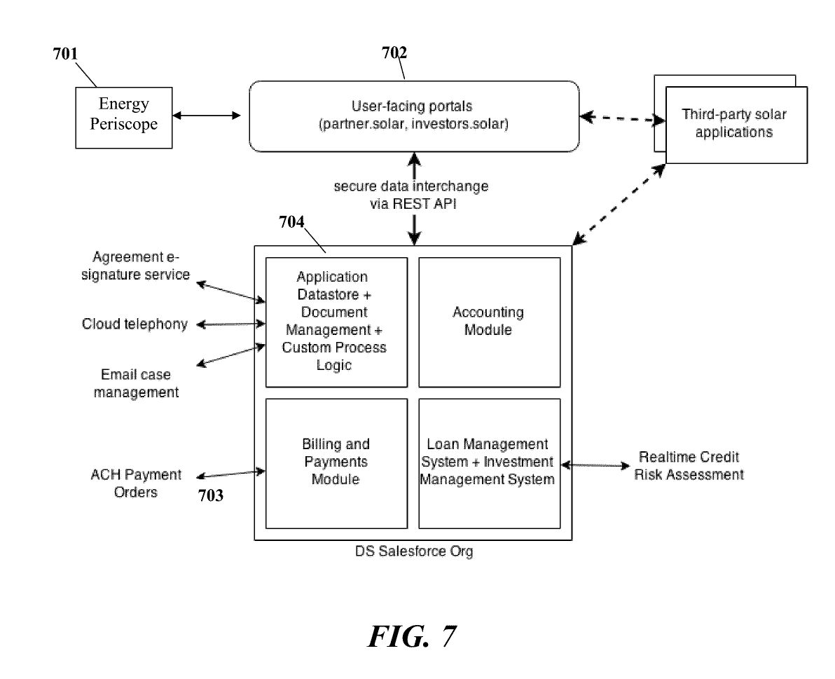

FIG. 7 schematically illustrates a system 700 that may be used to implement solar installation workflows of the present disclosure, in accordance with embodiments of the present invention. The system 700 may include an Energy Periscope 701 or other third party sales proposal and/or design software applications that provide information related to system hardware, performance projections, and applicant information-System 700 may also include a backbone 702 that hosts the front end systems. A payment module 703 may process payments, such as from a homeowner to a facilitator. A database 704 can store various data, such as homeowner data, investor data, installer data, and payment information. Additionally, the system 700 can include an accounting back-end (e.g., SalesForce®).

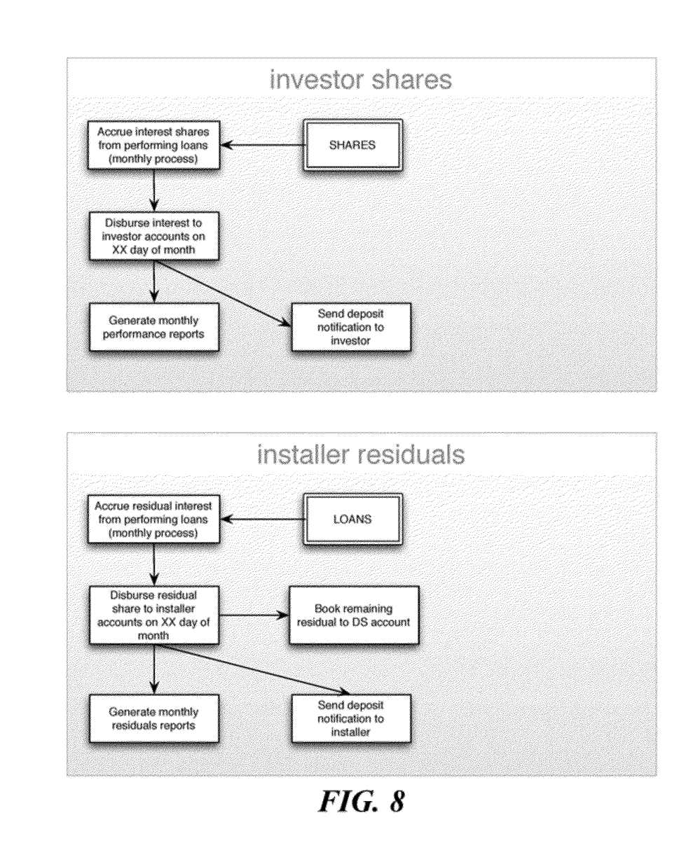

FIG. 8 schematically illustrates a performance process workflow, in accordance with embodiments of the present invention. The top portion of the figure is directed to investor shares. From shares issued to an investor, an investor can accrue interest shares on performing loans. This may be assessed on a periodic basis, such as daily, weekly, monthly, or yearly. The interest can be disbursed to investor accounts periodically, such as daily, weekly, monthly, or yearly. Investors can then be provided performance reports and provided with deposit notifications. The bottom portion of FIG. 8 is directed to installer residuals. This shows residual payments made to solar system installers that can be related to ongoing operations and maintenance agreement, which can include certain minimum performance requirements for the installer to qualify for receipt of such residual payments. Such payments can be accrued throughout each year and once a quarter each installation partner may receive disbursements of qualifying residual payments for the total financed amount of all qualifying solar systems for which it provides operations and maintenance services.

### Computer Systems

The present disclosure provides computer control systems that are programmed to implement methods of the disclosure. FIG. 9 shows a computer system 901 that is programmed or otherwise configured to facilitate solar installation financing. The computer system 901 can regulate various aspects of solar installation financing methods of the present disclosure, such as, for example, facilitating the processing of solar installation loans to customers (e.g., homeowners), the generation of promissory notes, the disbursement of funds to installers, the receipt of funds from investors, and the receipt of payment from customers.

The computer system 901 includes a central processing unit (CPU, also “processor” and “computer processor” herein) 905, which can be a single core or multicore processor, or a plurality of processors for parallel processing. The computer system 901 also includes memory or memory location 910 (e.g., random-access memory, read-only memory, flash memory), electronic storage unit 915 (e.g., hard disk), communication interface 920 (e.g., network adapter) for communicating with one or more other systems, and peripheral devices 925, such as cache, other memory, data storage and/or electronic display adapters. The memory 910, storage unit 915, interface 920 and peripheral devices 925 are in communication with the CPU 905 through a communication bus (solid lines), such as a motherboard. The storage unit 915 can be a data storage unit (or data repository) for storing data. The computer system 901 can be operatively coupled to a computer network (“network”) 930 with the aid of the communication interface 920. The network 930 can be the Internet, an internet and/or extranet, or an intranet and/or extranet that is in communication with the Internet. The network 930 in some cases is a telecommunication and/or data network. The network 930 can include one or more computer servers, which can enable distributed computing, such as cloud computing. The network 930, in some cases with the aid of the computer system 901, can implement a peer-to-peer network, which may enable devices coupled to the computer system 901 to behave as a client or a server.

The CPU 905 can execute a sequence of machine-readable instructions, which can be embodied in a program or software. The instructions may be stored in a memory location, such as the memory 910. Examples of operations performed by the CPU 905 can include fetch, decode, execute, and writeback.

The storage unit 915 can store files, such as drivers, libraries and saved programs. The storage unit 915 can store user data, e.g., user preferences and user programs. The computer system 901 in some cases can include one or more additional data storage units that are external to the computer system 901, such as located on a remote server that is in communication with the computer system 901 through an intranet or the Internet.

The computer system 901 can communicate with one or more remote computer systems through the network 930. For instance, the computer system 901 can communicate with a remote computer system of a user (e.g., homeowner, installer or investor). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 901 via the network 930.

Methods as described herein can be implemented by way of machine (e.g., computer processor) executable code stored on an electronic storage location of the computer system 901, such as, for example, on the memory 910 or electronic storage unit 915. The machine executable or machine readable code can be provided in the form of software. During use, the code can be executed by the processor 905. In some cases, the code can be retrieved from the storage unit 915 and stored on the memory 910 for ready access by the processor 905. In some situations, the electronic storage unit 915 can be precluded, and machine-executable instructions are stored on memory 910.

The code can be pre-compiled and configured for use with a machine have a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 901, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 901 can include or be in communication with an electronic display that comprises a user interface (UI) for providing a solar installation customer (e.g., homeowner), solar installer and an investor the ability to view various features of systems and methods of the present disclosure. The UI can enable a customer to input information to get qualified for solar installation financing, and provide an investor with solar installations that have been approved for solar financing or pending approval. Examples of UI's include, without limitation, a graphical user interface (GUI) and web-based user interface.

### Example 1

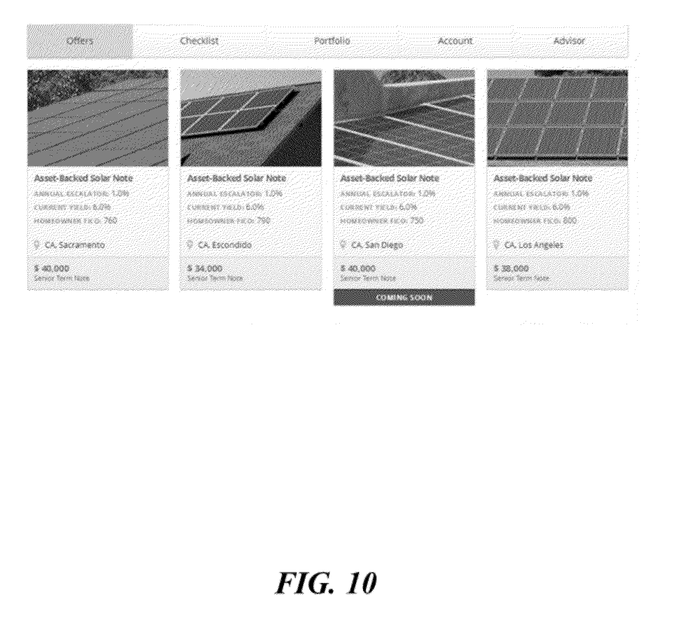

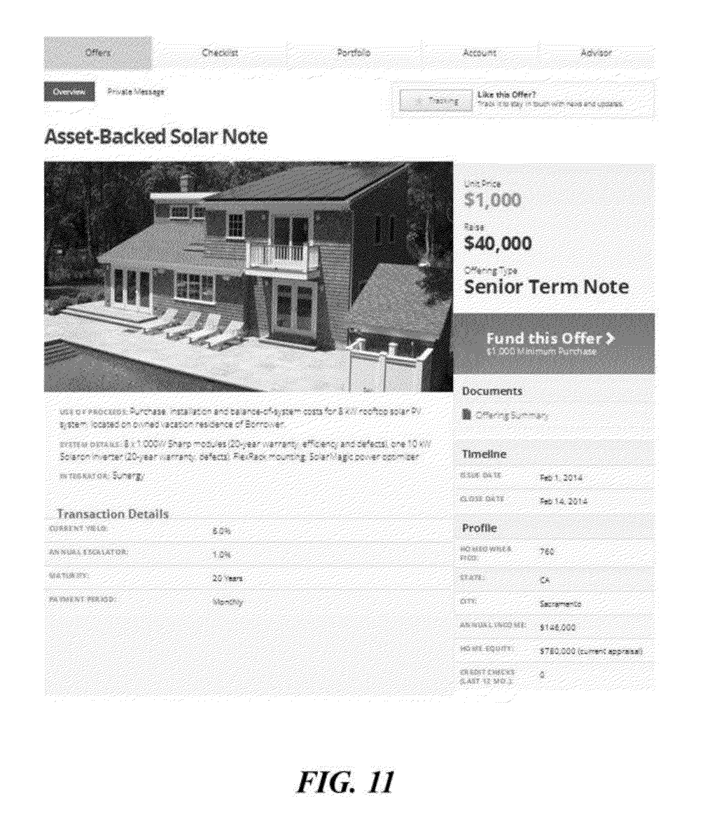

In an example, an investor can elect to fund at least a portion of a note. The investor can fund an asset-backed solar note. The investor can view associated dependent solar loans by accessing a UI of the system. The UI can be part of an investor front-end portal. FIG. 10 is a screenshot of an example investor portal. The portal shows four asset-backed solar notes. Each note provides information about the installation and performance metrics, such as current yield. Each note also shows information about the homeowner associated with the note, such as a credit score range of the homeowner. A loan amount associated with each note is also displayed. The investor can access a given note to view more information on the note and elect to participate in a given note. For example, by selecting the far-left note, the screen of FIG. 11 is displayed to the investor. The screen of FIG. 11 permits the investor to fund the offer at a minimum purchase of $1,000. The screen shows more information about the homeowner, such as annual income. The screen also shows a current yield of the note (6%) and maturity of the note (20 years).

### Example 2

A facilitator brings solar investors in contact with qualified solar customers that are homeowners. The facilitator offers loans to qualified homeowners at a 6.5% nominal interest rate, which is fewer than 100 basis points (1.00%) above the weighted average cost of capital (WACC) for the year 2020, and represents an immediate reduction in excess capital costs of around 600 bps in aggregate-which is fully 86% of the 2020 capital cost reduction goal of 700 bps.

While systems and methods of the present disclosure have been described in the context of solar installations, such systems and methods may be employed for use with other types of assets, such as energy efficiency appliances, battery backup and storage systems, fuel cell generators and natural gas micro-turbines.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for funding a solar system installation, the method comprising:
(a) receiving a request from a customer for a loan that is to be applied to an installation of a solar system at a location selected by said customer;
(b) using a computer processor, determining whether said customer pre-qualifies for said loan by comparing identifying information of said customer against one or more qualification criteria stored in memory;
(c) assigning said customer to an installer of said solar system, wherein said installer determines whether said location qualifies for said installation;
(d) if said customer and said location are eligible for said installation, (i) providing said customer with said loan, (ii) instructing said installer to proceed with said installation, and (iii) generating, using said computer processor, a note that corresponds to said loan, which note permits an investor to fund at least a portion of said loan; and
(e) providing said note to one or more potential investors for review.

2. The method of claim 1, further comprising determining that said customer's property is eligible for a loan that is to be applied to said installation of said solar system.

3. The method of claim 1, further comprising connecting the customer to an installer.

4. The method of claim 1, wherein the customer is a homeowner.

5. The method of claim 1, wherein the loan is additionally applied to post-installation operations.

6. The method of claim 1, wherein the loan is additionally applied to maintenance.

7. The method of claim 1, wherein the loan is additionally applied to demand response aggregation.

8. A non-transitory computer readable medium comprising program instructions for funding a solar system installation, the computer readable medium comprising:
a) program instructions for receiving a request from a customer for a loan that is to be applied to an installation of a solar system at a location selected by said customer;
b) program instructions for using a computer processor, determining whether said customer pre-qualifies for said loan-by comparing identifying information of said customer against one or more qualification criteria stored in memory;
c) program instructions for assigning said customer to an installer of said solar system, wherein said installer determines whether said location qualifies for said installation;
d) program instructions for, if said customer and said location are eligible for said installation, (i) providing said customer with said loan, (ii) instructing said installer to proceed with said installation, and (iii) generating, using said computer processor, a note that corresponds to said loan, which note permits an investor to fund at least a portion of said loan; and
e) program instructions for providing said note to one or more potential investors for review.

9. The computer readable medium of claim 8, wherein the one or more qualification criteria include borrower credit-risk.

10. The computer readable medium of claim 8, wherein the one or more qualification criteria include borrower contributions and obligations.

11. The computer readable medium of claim 8, wherein the one or more qualification criteria include presence of a backup loan servicer.

12. The computer readable medium of claim 8, wherein the installation is distributed to the installers based on at least one predetermined milestone.

13. The computer readable medium of claim 12, wherein the at least one predetermined milestone is an initial loan signing.

14. The computer readable medium of claim 12, wherein the at least one predetermined milestone is an equipment delivery.

15. The computer readable medium of claim 12, wherein the at least one predetermined milestone is system construction completion.

16. The computer readable medium of claim 12, wherein the at least one predetermined milestone is a grid interconnection.

17. A system for funding a solar system installation, the system comprising:
a) a communications interface that is in communication with an electronic device of a customer for a loan over a network, which customer is for a loan that is to be applied to an installation of a solar system at a location selected by said customer;
b) memory coupled to said communications interface, wherein said memory stores one or more qualification criteria of said customer; and
c) a computer processor coupled to said memory and programmed to (i) receive a request from said customer for said loan; (ii) determine whether said customer pre-qualifies for said loan by comparing identifying information of said customer against said one or more qualification criteria stored in said memory; (iii) assign said customer to an installer of said solar system, wherein said installer determines whether said location qualifies for said installation; (iv) if said customer and said location are eligible for said installation, provide said customer with said loan, instruct said installer to proceed with said installation, and generate a note that corresponds to said loan, which note permits an investor to fund at least a portion of said loan; and (v) provide said note to one or more potential investors for review.

18. The system of claim 17, wherein the computer processor is programmed to provide the note using a front-end investor platform.

19. The system of claim 18, wherein the front-end investor platform is a web platform.

20. The system of claim 17, wherein the computer processor is programmed to receive a request from an investor of the one or more potential investors to purchase a given unit of the note.
